(19) United States
(12) Patent Application Publication
(10) Pub. No.: US 2001/0055279 A1
(43) Pub. Date: Dec. 27, 2001

(54) Multiplexing technique for audio teleconferencing

(75) Inventor: Fumihiro Abe, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/858,652

(22) Filed: May 17, 2001

(30) Foreign Application Priority Data
May 18, 2000 (JP) 2000-145928

(51) Int. Cl. H04L 12/16

(52) U.S. Cl. 370/260; 370/535

(57) ABSTRACT

A multiplexing device allowing audio conferencing via a network with simplified circuit structure is disclosed. After combining received signals from all the participants to produce a combined signal, a signal of each of the participants is subtracted from the combined signal to produce a conference signal for a corresponding participant.

### BACKGROUND OF THE INVENTION

1. Field of the Invention

The present invention relates to multiplexing techniques for teleconferencing, and in particular to multiplexing method and device suitable for an audio conference system via a communication network.

2. Description of the Related Art

In audio teleconferencing, a voice multiplexing function is needed to transmit a speech from any participant to all the other participants and receive a speech from any of the other participants. In general, the audio conferencing has been provided by a conference function in a PBX (private branch exchange) or by the telephone companies.

Recently, there have been proposes several digital cordless telephone systems allowing audio conferencing among three or more handset telephone terminals as well as a party on the other end of telephone line.

For example, Japanese Patent Application Unexamined Publication No. 6-326779 discloses such a digital cordless telephone system composed of a base station connected to a telephone line and a plurality of handset telephone terminals connected to the base station by radio TDMA-TDD channels. The base station is provided with a plurality of memories each corresponding to receive time slots for the handset telephone terminals. Similarly, each of the handset telephone terminals is also provided with a plurality of memories each corresponding to receive time slots for the other handset telephone terminals and the base station. In such a system configuration, the voice multiplexing for telephone line transmission is performed by the base station storing voice data received from each of the handset telephone terminals into a corresponding memory and then adding all the stored voice data to transmit the added data to the party on the other end of the telephone line.

However, this conventional voice multiplexing technique needs memories as many as the number of receive time slots and further needs a pair of switching circuit and adding circuit for storing received voice data to one of the memories and adding the stored data to produce transmission data. Accordingly, when the number of terminals increases, the amount of hardware in the base station and the terminals is also increased.

Further, since the memories and a pair of switching circuit and adding circuit are needed for each terminal, the voice multiplexing becomes very complicated and costly in the whole system.

### SUMMARY OF THE INVENTION

An object of the present invention is to provide multiplexing method and device allowing audio conferencing via a network with simplified circuit structure.

According to the present invention, a device for producing a conference signal to be transmitted to each of participants of a conference, includes: a signal combiner for combining received signals from all the participants Lo produce a combined signal; and a signal subtracter for subtracting a signal of each of the participants from the combined signal to produce a conference signal for a corresponding participant.

The participants may be geographically dispersed, and the device may further includes a communication controller for establishing a connection to each of the participants to receive the signals from the participants and transmit the conference signal to the corresponding participant.

At least one of the participants may be connected through a communications network.

According to another aspect of the present invention, a voice multiplexer for producing a multiplexed voice signal for an audio communications session, includes: a first interface to a plurality of terminals; a second interface to a communications network; a communication controller controlling the first and second interfaces to establish a connection to each of the terminals and a connection to at least one party through the communications network; a signal combiner for combining a terminal voice signal received from the terminals through the first interface and a party voice signal received from at least one party through the second interface to produce a combined voice signal; a first signal subtracter for subtracting the terminal voice signal from the combined voice signal to produce a first multiplexed voice signal for a corresponding terminal; and a second signal subtracter for subtracting the party voice signal from the combined voice signal to produce a second multiplexed voice signal for a corresponding party.

The multiplexer may further include: a calling signal discriminator for discriminating a calling signal from terminal and party voice signals, wherein, when a calling signal is received from one of a terminal and a party that do not participate in the audio communications session yet, the communication controller establishes a connection to the one so as to participate in the audio communications session.

The multiplexer may further include: a destination address memory for registering a calling address of each of the terminals and the at least one party, wherein the communication controller uses the destination address memory to establish a connection to each of the terminals and a connection to at least one party through the communications network.

As described above, after combining received signals from all the participants to produce a combined signal, a signal of each of the participants is subtracted from the combined signal to produce a conference signal for a corresponding participant. Accordingly, the signal multiplexing for audio conferencing can be performed with simplified structure.

### BRIEF DESCRIPTION OF THE DRAWINGS

FIG. 1 is a schematic diagram showing the general configuration of an audio conference system according to the present invention;

FIG. 2 is a block diagram showing an internal circuit of a voice multiplexer of FIG. 1;

FIG. 3 is a block diagram showing a circuit of a multiplexing device according to an embodiment of the present invention;

FIG. 4 is a diagram showing a sequence of audio teleconferencing in the embodiment; and

FIG. 5 is a block diagram showing a generalized circuit of a multiplexing device according to the embodiment.

### DESCRIPTION OF THE PREFERRED EMBODIMENTS

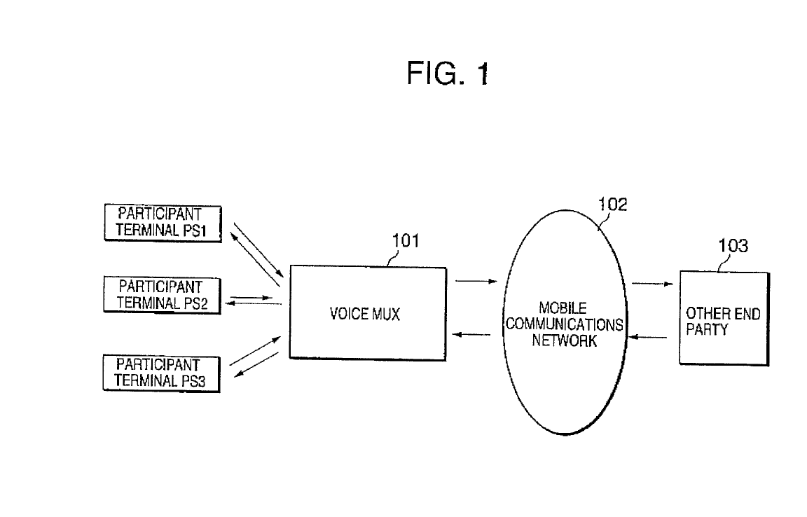

As shown in FIG. 1, it is assumed for simplicity that a voice multiplexer 101 accommodates three conference participant terminals PS1-PS3 and a party 103 on the other end of an established line through a mobile communications network 102.

Here, the conference participant terminals PS1-PS3 are connected to the voice multiplexer 101 by radio according to a predetermined wireless connection scheme such as PHS (Personal Handy-phone System) or Bluetooth™, The mobile communications network 102 may employ any mobile communications scheme such as GSM (Global System for Mobile communications), PDC (Personal Digital cellular), or IMT-2000 (International Mobile Telecommunications 2000).

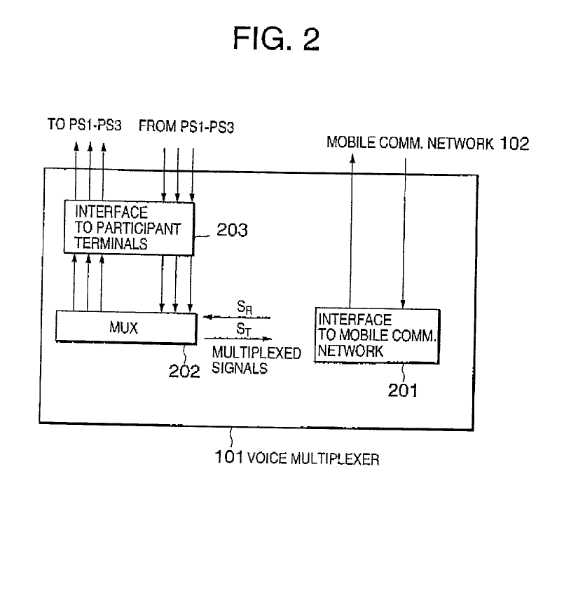

Referring to FIG. 2, the voice multiplexer 101 includes an interface 201 to the mobile communications network 102, a multiplexing device 202, and an interface 203 to the conference participant terminals PS1-PS3.

The voice multiplexer 101 further includes a communication controller (not shown), which controls the interface 201 to establish a connection to the other party 103 through the mobile communications network 102 and controls the interface 203 to establish connections to respective ones of the conference participant terminals PS1-PS3.

The interface 201, when receiving data from the other end party 103 through the mobile communications network 102, transfers the received voice signal S_{B} to the multiplexing device 202. When receiving a multiplexed transmission signal S_{T} from the multiplexing device 202, the interface 201 sends it to the other end party 103 through the mobile communications network 102.

The interface 203, when receiving transmission data from the conference participant terminals PS1-PS3, transfers it to the multiplexing device 202. When receiving voice data for respective ones of the conference participant terminals PS1-PS3 from the multiplexing device 202, the interface 203 sends them to respective ones of the conference participant terminals PS1-PS3.

As described in detail hereafter, the multiplexing device 202 performs multiplexing of voice data for audio conferencing.

### Multiplexing

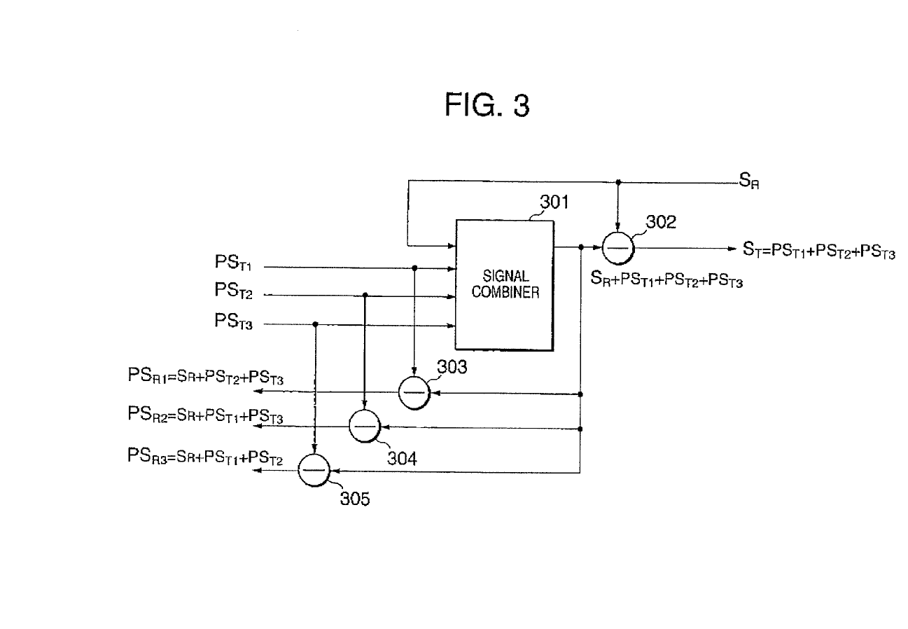

As shown in FIG. 3, the multiplexing device 202 includes a signal combiner 301 and voice subtracters 302-305.

The signal combiner 301 inputs voice signals PS_{T1}, PS_{T2}, and PS_{T3} from respective ones of the conference participant terminals PS1-PS3 and a received voice signal S_{R} from the interface 201. The signal combiner 301 combines them to produce a combined signal, which may be represented by (S_{R}+PS_{T1}+PS_{T2}+PS_{T3}).

The voice subtracter 302 inputs the combined signal (Sₙ+PS_{T1}+PS_{T2}+PS_{T3}) and the received voice signal S_{R}. The subtracter 302 subtracts the received voice signal S_{R} from the combined signal (S_{R}+PS_{T1}+PS_{T2}+PS_{T3}) to produce a multiplexed transmission signal (conference signal) S_{T}, which is represented by (PS_{T1}+PS_{T2}+PS_{T3}) . The multiplexed transmission signal S_{T}=PS_{T1}+PS_{T2}+PS_{T3} is transmitted to the other party 103 through the mobile communications network 102. In other words, the voice signals PS_{T1}, PS_{T2}, and PS_{T3} of the conference participant terminals PS1-PS3 are multiplexed to be transmitted to the other party 103 through the established line.

The combined signal (S_{R}+PS_{T1}+PS_{T2}+PS_{T3}) is also output to the voice subtracters 303-305. The voice subtracters 303-305 are provided corresponding to respective ones of the conference participant terminals PS1-PS3 and input the voice signals PS_{T1}, PS_{T2}, and PS^{T3} from corresponding ones of the conference participant terminals PS1-PS3, respectively.

The voice subtracter 303 inputs the combined signal (S_{R}+PS_{T1}+PS_{T2}+PS_{T3}) and the voice signal PS_{T1}. The subtracter 303 subtracts the voice signals PS, from the combined signal (S_{R}+PS_{T1}+PS_{T2}+PS_{T3}) to output a multiplexed voice signal (conference signal) PS_{R1}, which may be represented by (S_{R}+FS_{T2} +PS_{T1}), to the conference participant terminals PS1. Accordingly, the conference participant terminal PS1 receives voices from all the other participants.

Similarly, the voice subtracter 304 inputs the combined signal (S_{R}+PS_{T1}+PS_{T2}+PS_{T3}) and the voice signal PS_{T2}. The subtracter 304 subtracts the voice signals PS_{T2} from the combined signal (S_{R}+PS_{T1}+PS_{T2}+PS_{T3}) to output a multiplexed voice signal (conference signal) PS_{R2}, which may be represented by (S_{R}+PS_{T1}+PS_{T3}), to the conference participant terminal PS2. The voice subtracter 305 inputs the combined signal (S_{R}+PS_{T1}+PS_{T2}+PS_{T3}) and the voice signal PS_{T3}. The subtracter 305 subtracts the voice signals PS_{T3} from the combined signal (S_{R}+PS_{T1}+PS_{T2}+PS_{T3}) to output a multiplexed voice signal (conference signal) PS_{R3}, which may be represented by (S_{R}+PS_{T1}+PS_{T2}), to the conference participant terminal PS3.

In this manner, the multiplexing device 202 produces voice multiplexed signals (conference signals) allowing audio conferencing among the conference participant terminals PS1-PS3 as well as the party 103 on the other end of the line. Only the signal combiner 301 and the voice subtracters 302-305 are needed to produce the voice multiplexed signals. Therefore, even if the number of conference participant terminals is increased, the multiplexing device 202 can be easily formed by only increasing the number of input terminals of the signal combiner and the number of subtracters. In other words, the multiplexing device 202 can be easily applied to the case of N (N is an integer greater than 3) conference participant terminals.

It should be noted that the multiplexing device 202 composed of the signal combiner 301 and voice subtracters 302-305 may be inplemented by a program-controlled processor or a dedicated hardware circuit. In the case of the program-controlled processor, a program having the signal combining and subtracting functions as described above is executed on the processor.

### Operation sequence

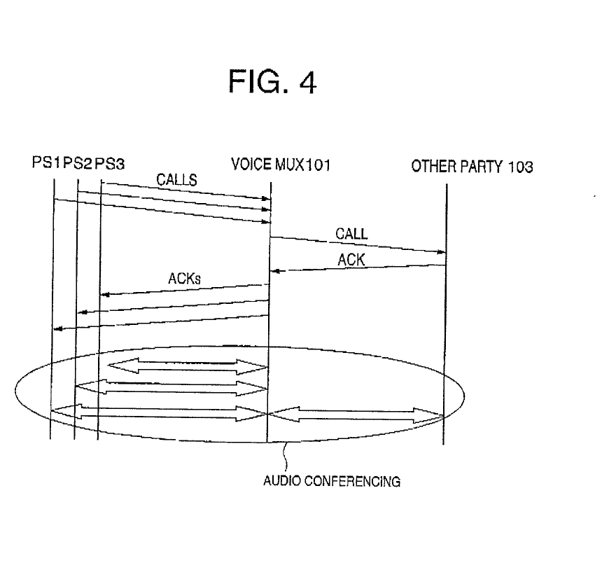

Referring to FIG. 4, when receiving calls to the other party 103 originated by the conference participant terminals PS1-PS3, the voice multiplexer 101 originates a single call to the other party 103 through the mobile communications network 102. When the other party 103 sends an acknowledge back to the voice multiplexer 101, the voice multiplexer lot sends acknowledges to the conference participant terminals PS1-PS3 and thereby a communication line between the conference participant terminals PS1-PS3 and the other party 103 is established through the mobile communications network 102. Similarly, when the other party 103 originates a call, the same communication line can be established.

Thereafter, the multiplexing device 202 performs the multiplexing of voice signals for audio conferencing as described above.

As described before, the present invention is not restricted to the case of three conference participant terminals. It is apparent that the present invention can be easily applied to the case of N (N is an integer greater than 3) conference participant terminals.

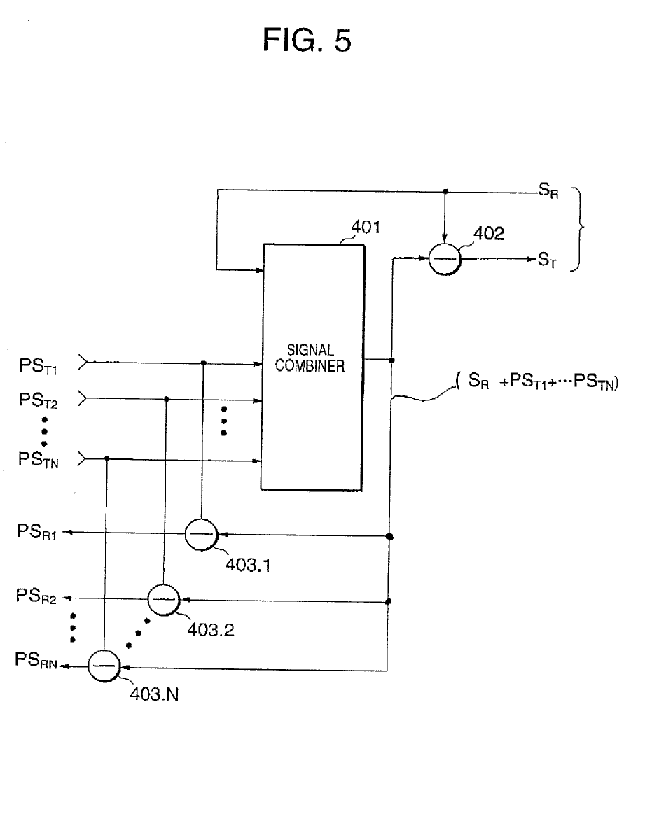

More specifically, as shown in FIG. 5, the multiplexing device 202 includes a signal combiner 401, a voice subtracter 402 in the network side, and voice subtracters 403.1 to 403.N in terminal side. Since the basic operation of this embodiment is the same as that of the first embodiment of FIG. 3, the details are omitted.

Preferably, a destination address memory like a phonebook may be provided in the above embodiments, allowing easy calling operation to the increased number of terminals and other parties.

Furthermore, a calling signal discriminator may be provided to discriminate a calling signal from voice signals during conference in the above embodiments. In this case, by calling another terminal or party during conference, that terminal or party can easily participate in the conference.

1. A device for producing a conference signal to be transmitted to each of participants of a conference, comprising:
a signal combiner for combining received signals from all the participants to produce a combined signal; and
a signal subtracter for subtracting a signal of each of the participants from the combined signal to produce a conference signal for a corresponding participant.

2. The device according to claim 1, wherein the participants are geographically dispersed, the device further comprising:
a communication controller for establishing a connection to each of the participants to receive the signals from the participants and transmit the conference signal to the corresponding participant.

3. The device according to claim 2, wherein at least one of the participants is connected through a communications network.

4. A voice multiplexer for producing a multiplexed voice signal for an audio communications session, comprising:
a first interface to a plurality of terminals;
a second interface to a communications network;
a communication controller controlling the first and second interfaces to establish a connection to each of the terminals and a connection to a party through the communications network;
a signal combiner for combining a terminal voice signal received from the terminals through the first interface and a party voice signal received from the party through the second interface to produce a combined voice signal;
a first signal subtracter for subtracting the terminal voice signal from the combined voice signal to produce a first multiplexed voice signal for a corresponding terminal; and
a second signal subtracter for subtracting the party voice signal from the combined voice signal to produce a second multiplexed voice signal for the party.

5. The multiplexer according to claim 4, further comprising:
a calling signal discriminator for discriminating a calling signal from terminal and party voice signals,
wherein, when a calling signal is received from one of a terminal and a party that do not participate in the audits communications session yet, the communication controller establishes a connection to the one so as to participate in the audio communications session.

6. The multiplexer according to claim 4, further comprising:
a destination address memory for registering a calling address of each of the terminals and the party, wherein the communication controller uses the destination address memory to establish a connection to each of the terminals and a connection to a party through the communications network.

7. A method for producing a conference signal to be transmitted to each of participants of a conference, comprising the steps of:
combining received signals from all the participants to produce a combined signal; and
subtracting a signal of each of the participants from the combined signal to produce a conference signal for a corresponding participant.

8. The method according to claim 7, wherein the participants are geographically dispersed, the method further comprising the step of:
establishing a connection to each of the participants to receive the signals from the participants and transmit the conference signal to the corresponding participant.

9. The method according to claim 8, wherein at least one of the participants is connected through a communications network.

10. A voice multiplexing method for producing a multiplexed voice signal for an audio communications session, comprising the steps of:
receiving a terminal voice signal from each of a plurality of terminals;
receiving a party voice signal from a party through a communications network;
combining terminal voice signals received from the terminals and the party voice signal received from the party to produce a combined voice signal;
subtracting the terminal voice signal from the combined voice signal to produce a first multiplexed voice signal for a corresponding terminal;
subtracting the party voice signal from the combined voice signal to produce a second multiplexed voice signal for the party; and
transmitting the first and second multiplexed voice signals to the corresponding terminal and the party, respectively.

11. The method according to claim 10, further comprising the steps of:
discriminating a calling signal from terminal and party voice signals; and
when a calling signal is received from one of a terminal and a party that do not participate in the audio communications session yet, establishing a connection to the one so as to participate in the audio communications session.

12. The method according to claim 10, further comprising the steps of;
registering a calling address of each of the terminals and the party in a destination address memory; and
using the destination address memory to establish a connection to each of the terminals and a connection to a party through the communicating network.

13. A recording medium storing a computer program for producing a conference signal to be transmitted to each of participants of a conference, the computer program comprising the steps of:
combining received signals from all the participants to produce a combined signal; and
subtracting a signal of each of the participants from the combined signal to produce a conference signal for a corresponding participant.

14. A recording medium storing a computer program for producing a multiplexed voice signal for an audio communications session, the computer program comprising the steps of:
receiving a terminal voice signal from each of a plurality of terminals;
receiving a party voice signal from a party through a communications network;
combining terminal voice signals received from the terminals and the party voice signal received from the party to produce a combined voice signal;
subtracting the terminal voice signal from the combined voice signal to produce a first multiplexed voice signal for a corresponding terminal;
subtracting the party voice signal from the combined voice signal to produce a second multiplexed voice signal for the party; and
transmitting the first and second multiplexed voice signals to the corresponding terminal and the corresponding party, respectively.
